(19) United States
(12) Patent Application Publication
(10) Pub. No.: US 2024/0028669 A1
(43) Pub. Date: Jan. 25, 2024

(54) EXPERIMENTALLY VALIDATING CAUSAL GRAPHS

(71) Applicant: Adobe Inc., San Jose, CA (US)

(72) Inventors: Vibhor Porwal, Auraiya (IN); Gaurav Sinha, Bangalore (IN)

(21) Appl. No.: 17/814,394

(22) Filed: Jul. 22, 2022

(51) Int. Cl. G06K 9/62; G06N 7/00

(52) U.S. Cl. CPC G06K 9/6297; G06N 7/005

(57) ABSTRACT

The present disclosure relates to systems, methods, and non-transitory computer-readable media that verify causal graphs utilizing nodes from corresponding Markov equivalence classes. For instance, in one or more embodiments, the disclosed systems receive a causal graph to be validated and a Markov equivalence class that corresponds to the causal graph. Additionally, the disclosed systems determine an intervention set using the causal graph, the intervention set comprising nodes from the Markov equivalence class. Using a plurality of interventions on the nodes of the intervention set, the disclosed systems determine whether the causal graph is valid.

### BACKGROUND

Recent years have seen significant advancement in hardware and software platforms for performing and communicating complex data analysis that reveals relationships between data features of a dataset. Many existing platforms, for example, utilize graphs that portray nodes representing the data features and edges that represent the relationships between those data features. In particular, these platforms often utilize causal graphs that include directed edges portraying the causal relationships among the data features. In many cases, such systems utilize the dataset to directly generate a Markov equivalence class that portrays a portion of these causal relationships.

### SUMMARY

One or more embodiments described herein provide benefits and/or solve one or more problems in the art with systems, methods, and non-transitory computer-readable media that efficiently verify a causal graph utilizing an intervention set of nodes from an equivalence class. Indeed, in one or more embodiments, a system verifies a causal graph—such as a directed acyclic graph—by determining whether the causal graph corresponds to a set of data (e.g., whether the causal graph portrays the correct causal relationships reflected in the set of data). To illustrate, in some embodiments, the system utilizes the causal graph to determine an intervention set that includes nodes of a corresponding equivalence class. In particular, the system utilizes the causal graph to identify nodes to add to the intervention set and/or nodes to omit from the intervention set. The system further intervenes on the nodes from the intervention set and determines whether the resulting edge orientations of the equivalence class correspond to the edge orientations of the causal graph. In this manner, the system flexibly and efficiently utilizes interventions to learn the edge orientations of an equivalence class to validate a corresponding causal graph.

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

This disclosure will describe one or more embodiments of the invention with additional specificity and detail by referencing the accompanying figures. The following paragraphs briefly describe those figures, in which:

FIG. 1 illustrates an example environment in which a causal graph validation system operates in accordance with one or more embodiments;

FIG. 2 illustrates an overview diagram of the causal graph validation system determining whether a causal graph is valid in accordance with one or more embodiments;

FIG. 3 illustrates a diagram for extracting a chain component from a Markov equivalence class in accordance with one or more embodiments;

FIG. 4 illustrates a diagram of an induced subgraph utilized by the causal graph validation system in accordance with one or more embodiments;

FIG. 5 illustrates a diagram of a clique utilized by the causal graph validation system in accordance with one or more embodiments;

FIG. 6 illustrates a diagram of a sink node utilized by the causal graph validation system in accordance with one or more embodiments;

FIG. 7 illustrates the causal graph validation system adding a sink node to a set of sink nodes in accordance with one or more embodiments;

FIG. 8 illustrates the causal graph validation system utilizing a set of sink nodes in determining an intervention set in accordance with one or more embodiments;

FIG. 9 illustrates a diagram for utilizing an intervention set to determine orientations for edges incident on a node of a Markov equivalence class in accordance with one or more embodiments;

FIG. 10 illustrates utilizing a Markov equivalence class with learned edge orientations to determine whether a causal graph a is valid in accordance with one or more embodiments;

FIG. 11 illustrates a causal graph utilized in determining the efficiency of the causal graph validation system via experiments in accordance with one or more embodiments;

FIG. 12 illustrates a graph reflecting experimental results regarding the efficiency of the causal graph validation system in accordance with one or more embodiments;

FIG. 13 illustrates an example schematic diagram of a feature recommendation system in accordance with one or more embodiments;

FIG. 14 illustrates a flowchart of a series of acts for verifying a causal graph using an intervention set in accordance with one or more embodiments; and

FIG. 15 illustrates a block diagram of an exemplary computing device in accordance with one or more embodiments.

### DETAILED DESCRIPTION

One or more embodiments described herein include a causal graph validation system that intervenes on a set of nodes of an equivalence class to validate a causal graph efficiently and flexibly. To illustrate, in one or more embodiments, the causal graph validation system utilizes a causal graph (e.g., induced subgraphs of the causal graph) to identify nodes from a corresponding equivalence class to include within an intervention set. The causal graph validation system further intervenes on the nodes from the intervention set to learn the orientations of undirected edges of the equivalence class. In some cases, the causal graph validation system also utilizes one or more rules to learn the orientations. In some cases, upon determining that an edge from the equivalence class has a different direction than the corresponding edge of the causal graph, the causal validation system determines that the causal graph is invalid. Otherwise, where the edge directions from both graphs are the same, the causal graph validation system determines that the causal graph is valid.

As indicated above, in one or more embodiments, the causal graph validation system determines whether a causal graph is valid. Indeed, in some embodiments, the causal graph validation system receives a causal graph (e.g., a directed acyclic graph) that portrays data features from a set of analytics data (e.g., observed data). The causal graph validation system determines whether the causal graph correctly portrays the causal relationships among those data features. In particular, in some cases, the causal graph validation system determines whether the directed edges of the causal graph are oriented to correctly portray the causal relationships. Where a causal graph correctly portrays the causal relationships, the causal graph validation system determines that the causal graph is valid in that it accurately reflects the set of analytics data.

In one or more embodiments, to determine whether a causal graph is valid, the causal graph validation system utilizes a Markov equivalence class that corresponds to the causal graph. For instance, in some cases, the Markov equivalence class includes some of the directed edges of the causal graph but also includes undirected edges. In some implementations, the causal graph validation system determines orientations (e.g., directions) for the undirected edges of the Markov equivalence class. The causal graph validation system further compares the orientations of the edges of the Markov equivalence class with the orientations of the edges of the causal graph to determine whether the causal graph is valid.

As mentioned above, in one or more embodiments, the causal graph validation system determines the orientations of the undirected edges of the Markov equivalence class using an intervention set that includes nodes from the Markov equivalence class. In some embodiments, the causal graph validation system determines the intervention set utilizing the causal graph. To illustrate, in some instances, the causal graph validation system generates or otherwise determines one or more induced subgraphs from the causal graph. Using the induced subgraphs, the causal validation system identifies nodes of the Markov equivalence class to add to the intervention set and/or nodes to omit from the intervention set.

In some implementations, the causal graph validation system intervenes on the nodes from the intervention set. For instance, the causal graph validation system intervenes on a node from the intervention set to determine the orientation of one or more edges that are incident on that node. In some cases, the causal graph validation system further utilizes one or more Meek rules to learn the orientation of one or more additional edges. For example, in some implementations, after intervening on a given node, the causal graph validation system applies the one or more Meek rules to determine the orientation of one or more edges not learned via the intervention.

In some instances, upon determining that the edge of the Markov equivalence class is oriented differently than the corresponding edge of the causal graph, the causal graph validation system determines that the causal graph is invalid. Accordingly, in some cases, the Markov equivalence class determines the invalidity of the causal graph before intervening on every node from the intervention set. In contrast, in some implementations, the causal graph validation system determines that the causal graph is valid upon determining that the edges of the Markov equivalence class are oriented in the same direction as the corresponding edges from the causal graph.

In some implementations, the causal graph validation system generates a validation indication that indicates the validity of a causal graph. For instance, in some cases, the causal graph validation system utilizes a binary validation indication that includes one value indicating validity of the causal graph and another value that indicates the causal graph is invalid. In some instances, the causal graph validation system provides the validity indication to a client device, such as the client device that submitted the causal graph for validation.

The causal graph validation system provides advantages over conventional systems. For example, conventional causal analysis systems suffer from technological shortcomings that result in inflexible and inefficient operation. To illustrate, many conventional systems fail to provide a flexible approach to validating causal graphs. Indeed, while some existing systems can learn edge orientations for a causal graph, such systems typically fail to provide a method of validating a causal graph that already includes the orientations.

Additionally, conventional causal analysis systems often fail to operate efficiently. In particular, conventional systems often utilize inefficient approaches to learn the edge orientations for a causal graph. For example, many conventional systems utilize a large number of interventions to learn edge orientations. Interventions, however, are computationally expensive, causing these systems to consume a significant amount of resources (e.g., memory and/or processing power). For instance, conventional systems may intervene on every node of a graph, intervene on subsets of nodes in increasing order of size, or intervene on nodes selected via a random process. These approaches often require a minimum number of n interventions (where n represents the number of nodes in the causal graph) or, at worst, an exponential number of interventions. Thus, these systems fail to implement an efficient approach that requires fewer computing resources via fewer interventions.

The causal graph validation system operates with improved flexibility when compared to conventional systems. For instance, the causal graph validation system offers a flexible approach to validating a causal graph. In particular, the causal graph validation system flexibly utilizes interventions on a Markov equivalence class to determine whether the directed edges of a corresponding causal graph correctly portray the causal relationships reflected in the underlying analytics data. Indeed, the causal graph validation system utilizes an unconventional ordered combination of actions unavailable under conventional systems to identify an intervention set and intervene on the nodes of the intervention set to determine whether a causal graph is valid.

Additionally, the causal graph validation system operates with improved efficiency. In particular, by determining edge orientations via interventions on an intervention set of nodes, the causal graph validation system reduces the number of interventions required to learn the edge orientations when compared to conventional systems. Indeed, using the process described herein, the causal graph validation system performs, at most, twice the minimum number of interventions required to learn the edge orientations of a causal graph. By reducing the number of interventions, the causal graph validation system further reduces the computing resources that are consumed when compared to conventional systems.

As illustrated by the foregoing discussion, the present disclosure utilizes a variety of terms to describe features and benefits of the causal graph validation system. Additional detail is now provided regarding the meaning of these terms. For example, as used herein, the term “analytics data” includes data collected in association with some entity (e.g., a person, a business, a model, a process, a platform, a product) or group of entities. In particular, in some embodiments, analytics data includes data collected for analysis of behavior exhibited by an entity, behavior exhibited in response to an entity, or results affected by an entity or group of entities. For instance, in some cases, analytics data includes data metrics that measure engagement with a computer-implemented platform, such as the website of a business (e.g., the users that engage with the platform, the length of engagement, the patch to engagement, pages most visited, etc.). As another example, in some implementations, analytics data includes data regarding users that interact with a computer-implemented platform (e.g., demographic data, devices used, history of engagement, etc.). Thus, in several embodiments, analytics data reflects various data features and can provide quantitative or qualitative measurements related to those data features.

Additionally, as used herein, the term “causal graph” refers to a graph structure that portrays causal relationships among the nodes included therein. In particular, in some cases, a causal graph corresponds to a set of data (e.g., a set of analytics data) and includes nodes that represent data features from the set of data and directed edges between nodes that represent causal relationships among those data features. In some embodiments, a causal graph includes a probabilistic graphical model that represents a set of variables (e.g., data features) and their conditional dependencies. To illustrate, in some implementations, a causal graph includes a directed acyclic graph (DAG) or Bayesian network (e.g., a Causal Bayesian Network) where nodes represent random variables and the joint distribution factors are a product of conditionals of node on their parents. As another example, in some cases, a causal graph includes a partially directed graph.

Further, as used herein, the term “Markov equivalence class” refers to a graph or graphical model that represents a set of causal graphs. In particular, in some embodiments, a Markov equivalence class includes a graphical model that reflects commonalities among a corresponding set of causal graphs. For instance, in some cases, the set of causal graphs share the same set of nodes, so the Markov equivalence class includes a corresponding set of nodes. Further, in some instances, the Markov equivalence class includes a directed edge having an orientation between a pair of nodes where all of the represented causal graphs include the same directed edge with the same orientation. In some embodiments, a Markov equivalence class further includes undirected edges. Thus, in some implementations, a Markov equivalence class is a partially directed graph or an undirected graph. Further, in some cases, a Markov equivalence class includes chain components, such as chordal chain components. Indeed, in some instances, a Markov equivalence class includes a chain graph that does not include directed cycles.

As used herein, the term “orientation” refers to a direction of an edge represented in a graph, such as a causal graph or a Markov equivalence class. In particular, in some embodiments, an orientation refers to the particular direction of a directed edge included in a graph. For example, when considering a pair of adjacent nodes connected by a directed edge, an orientation refers to the direction of the directed edge between the nodes (e.g., whether the directed edge points from the first node to the second node or points from the second node to the first node). In some cases, the orientation of a directed edge represents a causal relationship or a dependency between the nodes (e.g., the data features represented by the nodes) connected by the directed edge.

Additionally, as used herein, the term “chain component” refers to a subset of nodes of a graph, such as a Markov equivalence class, that are connected via undirected edges. For instance, in one or more embodiments, the causal graph validation system determines or identifies the chain components of a Markov equivalence class by removing the directed edges of the Markov equivalence class or otherwise partitioning the Markov equivalence class into subsets of nodes that exclude its directed edges. Relatedly, as used herein, the term “chordal chain component” refers to a chain component having an induced cycle of, at most, three nodes. In particular, in some embodiments, a chordal chain component includes a chain component that includes a chord where a represented cycle includes four or more nodes (e.g., where the chord is not part of the cycle but connects to nodes of the cycle).

Further, as used herein, the term “induced subgraph” refers to a subgraph that is formed from a portion of another graph. In particular, in some embodiments, an induced subgraph of a graph (e.g., a causal graph or a Markov equivalence class) includes a subgraph formed from a subset of nodes of the graph as well as the edges of the graph that connect those nodes. In some cases, the edges used to form an induced subgraph include directed edges of the graph. In some implementations, the edges include undirected edges.

As used herein, the term “clique” refers to a set of nodes where every node in the set is adjacent to every other node in the set. In particular, in some embodiments, a clique includes a subset of nodes from a graph where every node in the subset is connected to every other node in the subset via an edge from the graph. In some cases, a clique further includes the edges that connect then nodes. Relatedly, as used herein, the term “maximal clique” refers to a clique that is of the largest size available via its corresponding graph. For instance, in some cases, a clique that includes a subset of nodes and edges from a graph is a maximal clique if no other node from the graph is connected to every node in the clique. In other words, a clique is a maximal clique if it would no longer be a clique if any other node from the graph was included. Indeed, while one or more nodes of a maximal clique may be connected to other nodes from its corresponding graph, they are not connected in a manner that would still form a clique if those nodes were added.

Additionally, as used herein, the term “sink node” includes a node of a graph or a portion of a graph that includes only incoming edges. In particular, in some embodiments, a sink node includes a node that is not connected to another node via an outgoing edge (e.g., an edge pointing from the sink node to the other node). For instance, in some cases, a sink node includes a node from a directed graph (or a portion of a directed graph) where all edges that are incident on that node are incoming edges.

Further, as used herein, the term “Meek rule” refers to a rule for orienting one or more edges of a graph. In particular, in some embodiments, a Meek rule includes a rule-of-thumb for determining the orientation of an edge of a graph based on the orientation of one or more other edges of the graph. For instance, in some cases, as will be discussed below, the causal graph validation system utilizes one or more Meek rules to orient edges of a Markov equivalence class after using an intervention on a node of the Markov equivalence class.

As used herein, the term “intervention” refers to a process for manipulating one or more nodes of a graph. In particular, in some embodiments, an intervention includes a process of manipulating a graph so that a particular node (or set of nodes) is set with a fixed value. As will be discussed below, in some cases, the causal graph validation system utilizes interventions to determine the causal relationships between nodes and orient the edges connecting those nodes accordingly. Relatedly, as used herein, the term “intervention set” includes a set of nodes designated for intervention. For example, in some implementations, an intervention set includes a set of nodes chosen from a Markov equivalence class, using a corresponding causal graph, for intervention to determine the orientations of undirected edges from the Markov equivalence class.

Additionally, as used herein, the term “validation indication” includes an indication (e.g., a communication) of whether a causal graph is valid. In particular, in some embodiments, a validation indication includes an indication of whether a causal graph correctly represents the causal relationships reflected in a corresponding set of analytics data. In some cases, a validation indication is a binary indicator that includes one value indicating that a causal graph is invalid or another value indicating that the causal graph is valid. In some cases, however, a validation indication indicates a rating or percentage that indicates how close a causal graph is to correctly representing the causal relationships reflected in the corresponding set of analytics data (e.g., the number or percentage of directed edges with the correct orientation).

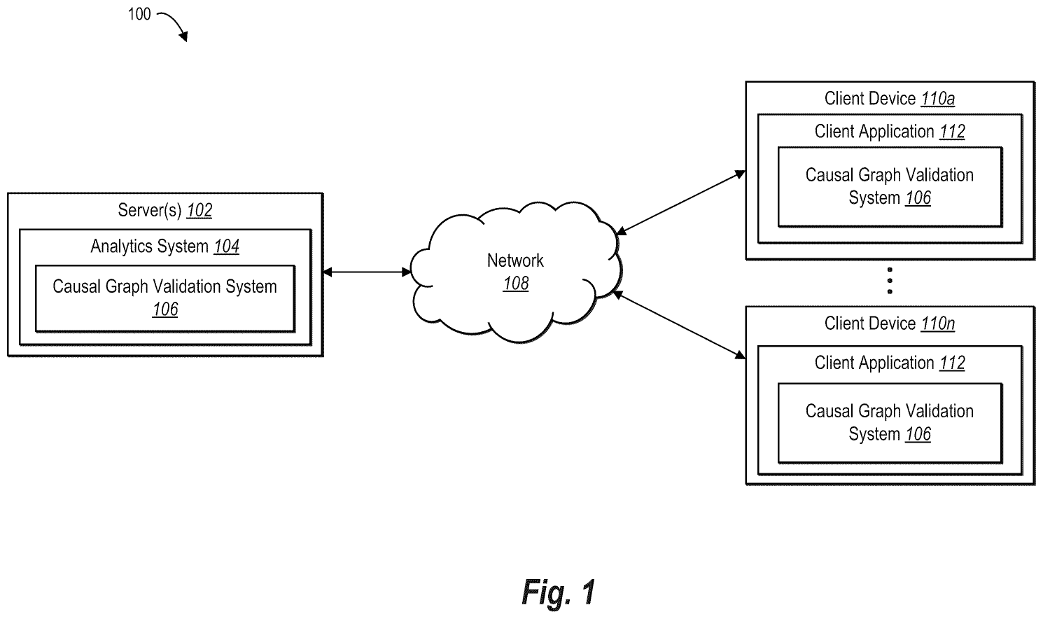

Additional detail regarding the causal graph validation system will now be provided with reference to the figures. For example, FIG. 1 illustrates a schematic diagram of an exemplary system 100 in which a causal graph validation system 106 operates. As illustrated in FIG. 1, the system 100 includes a server(s) 102, a network 108, and client devices 110a-110n.

Although the system 100 of FIG. 1 is depicted as having a particular number of components, the system 100 is capable of having any number of additional or alternative components (e.g., any number of servers, client devices, or other components in communication with the causal graph validation system 106 via the network 108). Similarly, although FIG. 1 illustrates a particular arrangement of the server(s) 102, the network 108, and the client devices 110a-110n, various additional arrangements are possible.

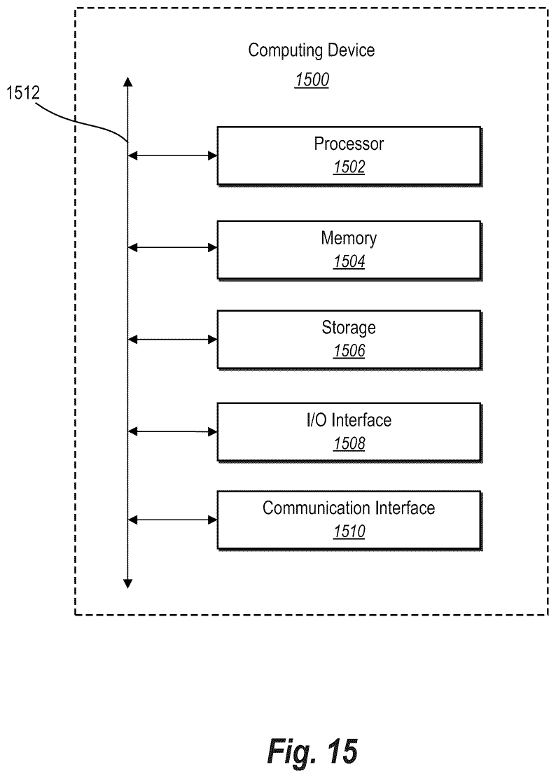

The server(s) 102, the network 108, and the client devices 110a-110n are communicatively coupled with each other either directly or indirectly (e.g., through the network 108 discussed in greater detail below in relation to FIG. 15). Moreover, the server(s) 102 and the client devices 110a-110n include one or more of a variety of computing devices (including one or more computing devices as discussed in greater detail with relation to FIG. 15).

As mentioned above, the system 100 includes the server(s) 102. In one or more embodiments, the server(s) 102 generates, stores, receives, and/or transmits data including graphs (e.g., causal graphs and/or corresponding Markov equivalence classes) and validation indications. In one or more embodiments, the server(s) 102 comprises a data server. In some implementations, the server(s) 102 comprises a communication server or a web-hosting server.

In one or more embodiments, the analytics system 104 provides functionality for analyzing datasets and/or providing analysis results (e.g., metrics, reports, visualizations, or other data indicating determinations made via the analysis). For instance, in some cases, the analytics system 104 receives or otherwise accesses a set of analytics data (e.g., observed data). In some implementations, the analytics system 104 additionally or alternatively receives other data corresponding to the set of analytics data (e.g., a causal graph derived from the set of analytics data). The analytics system 104 then provides an analysis of the set of analytics data or the other data.

In one or more embodiments, the client devices 110a-110n include computing devices that can access, view, modify, store, and/or provide, for display, analytics data and/or results from an analysis of the analytics data. For example, the client devices 110a-110n include smartphones, tablets, desktop computers, laptop computers, head-mounted-display devices, or other electronic devices. The client devices 110a-110n include one or more applications (e.g., the client application 112) that can access, view, modify, store, and/or provide, for display, analytics data and/or results from an analysis of the analytics data. For example, in one or more embodiments, the client application 112 includes a software application installed on the client devices 110a-110n. Additionally, or alternatively, the client application 112 includes a web browser or other application that accesses a software application hosted on the server(s) 102 (and supported by the analytics system 104).

To provide an example implementation, in some embodiments, the causal graph validation system 106 on the server(s) 102 supports the causal graph validation system 106 on the client device 110n. For instance, in some cases, the causal graph validation system 106 on the server(s) 102 learns parameters for a computer-implemented model or algorithm that generates a Markov equivalence class from a set of analytics data. The causal graph validation system 106 then, via the server(s) 102, provides the computer-implemented model or algorithm to the client device 110n. In other words, the client device 110n obtains (e.g., downloads) the computer-implemented model or algorithm from the server(s) 102. Once downloaded, the causal graph validation system 106 on the client device 110n utilizes the computer-implemented model or algorithm to generate Markov equivalence classes from analytics data independent from the server(s) 102. In some cases, the causal graph validation system 106 on the client device 110n further receives the algorithm for validating a causal graph using its corresponding Markov equivalence class from the server(s) 102.

In alternative implementations, the causal graph validation system 106 includes a web hosting application that allows the client device 110n to interact with content and services hosted on the server(s) 102. To illustrate, in one or more implementations, the client device 110n accesses a software application supported by the server(s) 102. In response, the causal graph validation system 106 on the server(s) 102 searches generates a Markov equivalence class and/or determines whether a causal graph is valid using the Markov equivalence class. The server(s) 102 then provides the analysis results (e.g., the validation indication) to the client device 110n for display.

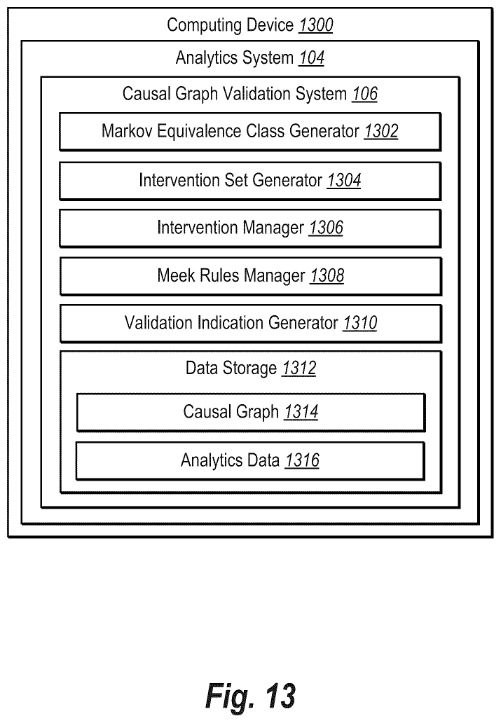

Indeed, the causal graph validation system 106 is able to be implemented in whole, or in part, by the individual elements of the system 100. Indeed, although FIG. 1 illustrates the causal graph validation system 106 implemented with regard to the server(s) 102, different components of the causal graph validation system 106 are able to be implemented by a variety of devices within the system 100. For example, in some cases, one or more (or all) components of the causal graph validation system 106 are implemented by a different computing device (e.g., one of the client devices 110a-110n) or a separate server from the server(s) 102 hosting the analytics system 104. Indeed, as shown in FIG. 1, the client devices 110a-110n include the causal graph validation system 106. Example components of the causal graph validation system 106 will be described below with regard to FIG. 13.

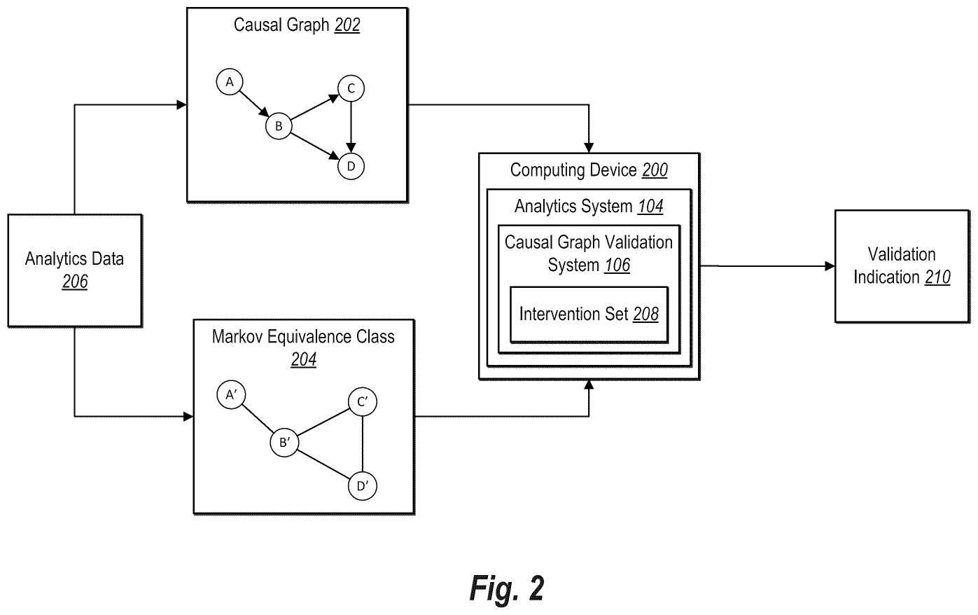

As previously mentioned, in one or more embodiments, the causal graph validation system 106 verifies a causal graph utilizing a corresponding Markov equivalence class. In particular, in some cases, the causal graph validation system 106 determines whether the causal graph is valid (e.g., correctly represents the causal relationships reflected in the underlying set of analytics data). FIG. 2 illustrates an overview diagram of the causal graph validation system 106 determining whether a causal graph is valid in accordance with one or more embodiments.

In at least one embodiment, the causal graph validation system 106 utilizes causal graphs, such as Causal Bayesian Networks to model causal relationships in data. As previously mentioned, in some cases, such graphs include a DAG where the nodes represent random variables and the joint distribution factors are a product of conditionals of nodes on their parents. In some embodiments, the causal graph validation system 106 represents a causal graph as follows where V₁, . . . , Vₙ denote the nodes and pa(Vᵢ) denotes the set of parents of Vᵢ.

$$ℙ ( {V}_{1} , … , {V}_{n} ) = {\prod }_{i = 1}^{n} ℙ ( {V}_{i} \vert pa ( {V}_{i} ) ) \qquad ( 1 )$$

As mentioned, in some embodiments, the causal graph validation system 106 determines whether a given causal graph is valid. Indeed, as shown in FIG. 2, the causal graph validation system 106 receives a causal graph 202 to be validated. For instance, in some cases, the causal graph validation system 106 receives the causal graph 202 from a client device or other computing device (e.g., a computing device hosting a third-party system). In some cases, the causal graph validation system 106 retrieves the causal graph 202 from a local or remote storage location.

As further shown in FIG. 2, the causal graph validation system 106 also receives a Markov equivalence class 204. In some embodiments, the Markov equivalence class 204 corresponds to the causal graph 202. In other words, the Markov equivalence class 204 is associated with (e.g., based on) the same set of underlying data that is associated with the causal graph 202. Indeed, as shown in FIG. 2, the causal graph 202 and the Markov equivalence class 204 are both associated with a set of analytics data 206. Accordingly, the causal graph 202 and the Markov equivalence class both include nodes that represent random variables (e.g., data features) reflected in the set of analytics data 206. As indicated in FIG. 2, the causal graph 202 is a directed graph, including directed edges that reflect the causal relationships of the set of analytics data 206. In contrast, the Markov equivalence class 204 is an undirected graph.

As mentioned, in some cases, the causal graph validation system 106 receives the Markov equivalence class 204 (e.g., from the same computing device or storage location as the causal graph 202). In some implementations, however, the causal graph validation system 106 generates the Markov equivalence class 204. In particular, in some embodiments, the causal graph validation system 106 generates the Markov equivalence class 204 from the set of analytics data 206. For instance, in some embodiments, the causal graph validation system 106 generates the Markov equivalence class 204 from the set of analytics data 206 utilizing a causal structure learning algorithm. To illustrate, in some instances, the causal graph validation system 106 utilizes the Greedy Equivalence Search (GES) algorithm described by David Maxwell Chickering, Optimal Structure Identification with Greedy Search, J. Mach. Learn. Res., 3:507-554, 2002 or the PC algorithm described by Peter Spirtes et al., Causation, Prediction, and Search, Second Edition, Adaptive Computation and Machine Learning, MIT Press, 2000, both of which are incorporated herein by reference in their entirety.

As shown in FIG. 2, the causal graph validation system 106 analyzes the causal graph 202 and the Markov equivalence class 204 to determine whether the causal graph 202 is valid. For example, as illustrated in FIG. 2, in some implementations, the causal graph validation system 106 operates on a computing device 200 (e.g., the server(s) 102 or one of the client devices 110a-110n discussed above with reference to FIG. 1 or some other mobile computing device, such as smart phone or tablet). Accordingly, the causal graph validation system 106 receives (or generates) the causal graph 202 and Markov equivalence class 204 at the computing device 200 and performs the analysis in response.

As indicated by FIG. 2, the causal graph validation system 106 utilizes an intervention set 208 to determine whether the causal graph 202 is valid. In particular, in some embodiments, the intervention set 208 includes nodes from the Markov equivalence class 204, and the causal graph validation system 106 intervenes on one or more of the nodes. Thus, as will be discussed further below, the causal graph validation system 106 learns orientations for edges (e.g., undirected edges) of the Markov equivalence class 204 and determines whether the causal graph 202 is valid based on the orientations.

Indeed, in one or more embodiments, the causal graph validation system 106 can learn a causal graph up to its corresponding Markov equivalence class (e.g., using one of the aforementioned causal structure learning algorithms) but cannot learn the entire causal graph directly from the corresponding set of analytics data. Accordingly, in some cases, the causal graph validation system 106 learns the causal graph from its Markov equivalence class by determining edge orientations via interventions. Thus, the causal graph validation system 106 determines an intervention set and intervenes on the included nodes to facilitate learning the entire causal graph.

As shown in FIG. 2, the causal graph validation system 106 generates a validation indication 210 that indicates whether the causal graph is valid. In some cases, the causal graph validation system 106 provides the validation indication 210 to a computing device, such as the computing device that submitted the causal graph 202 for validation.

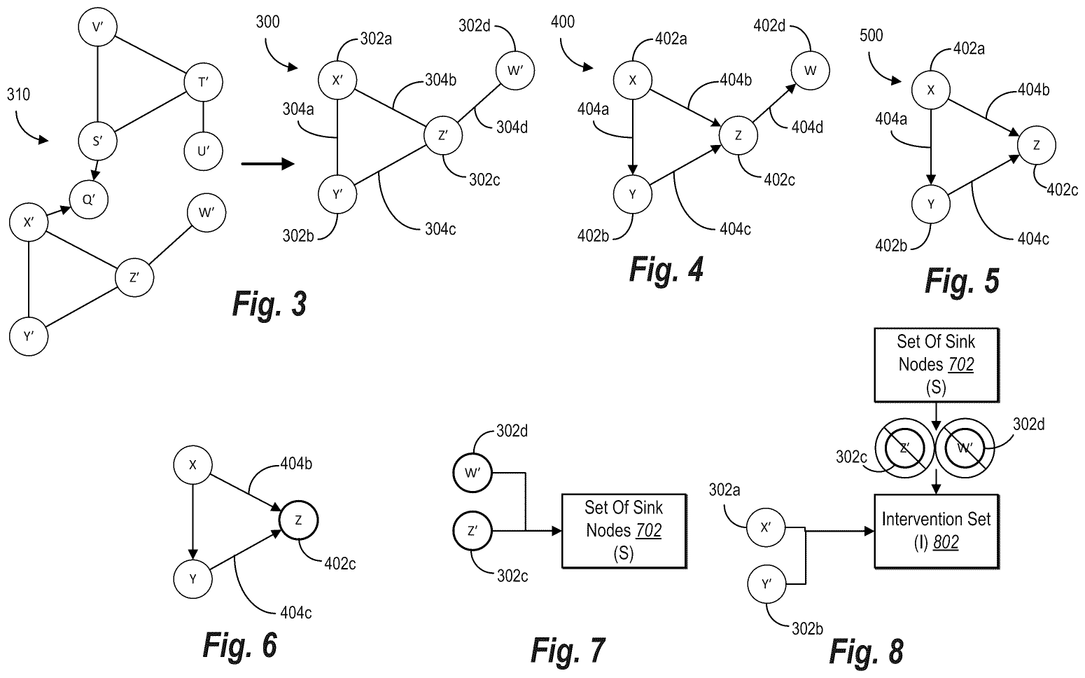

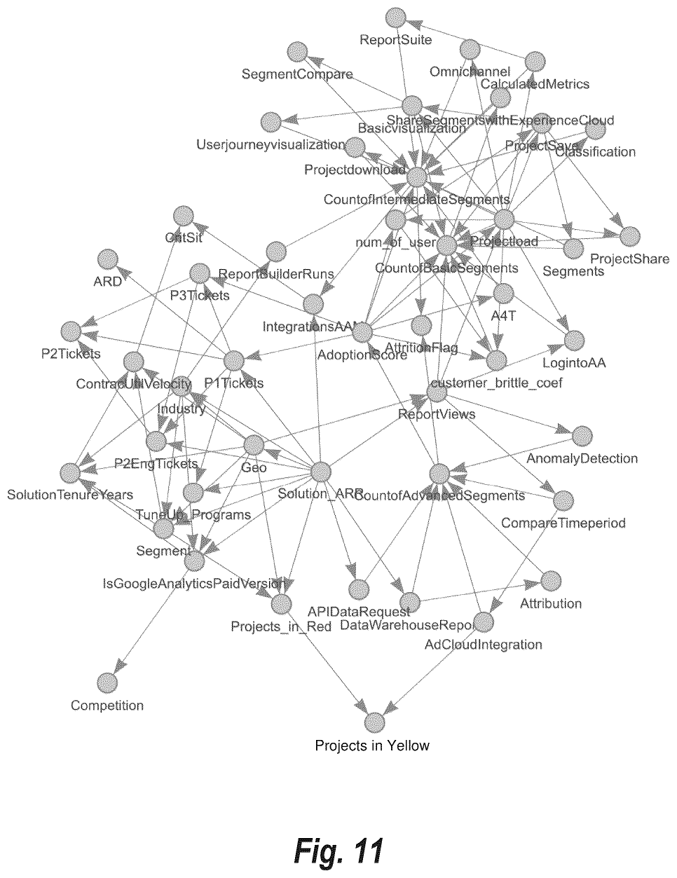

As just discussed, in one or more embodiments, the causal graph validation system 106 utilizes a Markov equivalence class in determining whether a corresponding causal graph is valid. In particular, as will be discussed in more detail below, the causal graph validation system 106 utilizes graph components of the causal graph and/or the Markov equivalence class to identify and implement an intervention set in determining whether the causal graph is valid. FIGS. 3-10 illustrate diagrams of graph components utilized by the causal graph validation system 106 in determining whether a causal graph is valid in accordance with at least one embodiment. It should be noted that FIGS. 3-10 presents graph components, rather than entire graphs, to simplify the discussion. A more thorough example of a graph upon which the causal graph validation system 106 can operate is shown in FIG. 11.

In some instance, the causal graph validation system 106 utilizes a chain component of the Markov equivalence class in determining whether the causal graph is valid. FIG. 3 illustrates a diagram of a chain component 300 utilized by the causal graph validation system 106 in accordance with one or more embodiments. As indicated in FIG. 3, in some implementations, the causal graph validation system 106 extracts the chain component 300 from the Markov equivalence class 310 (with FIG. 3 illustrating only a portion) by removing the directed edges from the Markov equivalence class 310. The causal graph validation system 106 further identifies the chain component 300 from the remainder of the Markov equivalence class 310.

As shown in FIG. 3, the chain component 300 includes nodes 302a-302d connected by edges 304a-304d. Further, as illustrated, the edges 304a-304d include undirected edges. In other words, the edges 304a-304d are associated with orientations that have yet to be determined. Thus, FIG. 3 indicates that the chain component 300 represents a portion of the Markov equivalence class 310 that remains after removal of its directed edges. For instance, in some cases, at least one of the nodes 302a-302d (e.g., the node 302a) was connected to the rest of the Markov equivalence class 310 via a directed edge. Thus, by removing the directed edges, the causal graph validation system 106 isolates the chain component 300.

In one or more embodiments, the causal graph validation system 106 extracts a set of chain components from the Markov equivalence class 310. Accordingly, the causal graph validation system 106 utilizes multiple chain components in determining whether the causal graph is valid. Further, in one or more embodiments, at least one of the chain components determined from the Markov equivalence class includes a chordal chain component. In other words, in some cases, the chain component is chorded so that it does not have an induced cycle length of more than three.

In some embodiments, the causal graph validation system 106 further utilizes an induced subgraph of the causal graph in determining whether the causal graph is valid. FIG. 4 illustrates a diagram of an induced subgraph 400 utilized by the causal graph validation system 106 in accordance with one or more embodiments.

As shown in FIG. 4, the induced subgraph 400 determined from the causal graph corresponds to the chain component 300 extracted from the Markov equivalence class. In particular, the induced subgraph 400 includes nodes 402a-402d that correspond to the nodes 302a-302d of the chain component 300 as well as edges 404a-404d that correspond to the edges 304a-304d of the chain component 300. It should be noted, however, that the edges 404a-404d of the induced subgraph 400 include directed edges as they come from a directed graph.

Thus, in one or more embodiments, the causal graph validation system 106 utilizes the chain component 300 extracted from the Markov equivalence class to generate the induced subgraph 400 from the causal graph. For instance, in some cases, the causal graph validation system 106 utilizes the chain component 300 to identify corresponding nodes and edges in the causal graph. The causal graph validation system 106 further generates the induced subgraph 400 utilizing the identified nodes and edges.

In one or more embodiments, the causal graph validation system 106 generates a set of induced subgraphs from the causal graph. For instance, in some implementations, the causal graph validation system 106 extracts multiple chain components from the Markov equivalence class and generates, from the causal graph, an induced subgraph for each chain component. Accordingly, in some instances, the causal graph validation system 106 utilizes a plurality of induced subgraphs in determining whether the causal graph is valid.

In one or more embodiments, the causal graph validation system 106 determines a clique from the induced subgraph 400 generated from the causal graph. FIG. 5 illustrates a diagram of a clique 500 utilized by the causal graph validation system 106 in accordance with one or more embodiments.

As shown in FIG. 5, the clique 500 includes a set of adjacent nodes from the induced subgraph 400. In particular, the clique 500 includes the nodes 402a-402c from the induced subgraph 400. As further shown, the clique 500 includes the edges 404a-404c from the induced subgraph 400. Thus, in one or more embodiments, the causal graph validation system 106 determines the clique 500 from the induced subgraph 400 by identifying adjacent nodes.

In one or more embodiments, the causal graph validation system 106 identifies the clique 500 by identifying a maximal clique from the induced subgraph 400. Indeed, as shown in FIG. 5, the clique 500 includes a maximal clique. In particular, the clique 500 could not also include the node 402d (or the edge 404d) from the induced subgraph 400 as the node 402d is adjacent to neither the node 402a nor the node 402b.

In some implementations, however, the causal graph validation system 106 identifies multiple cliques (e.g., multiple maximal cliques) from the same induced subgraph. For instance, in some cases, the causal graph validation system 106 identifies a clique consisting of the node 402c and the node 402d (as well as the edge 404d) from the induced subgraph 400. Thus, while the node 402d is not included in the clique 500, the causal graph validation system 106 includes the node 402d in a separate clique in some implementations.

Thus, in some implementations, the causal graph validation system 106 determines a set of cliques (e.g., a set of maximal cliques) from a causal graph. Indeed, in some cases, the causal graph validation system 106 determines multiple cliques for an induced subgraph. In some cases, the causal graph validation system 106 determines one or more cliques for each induced subgraph from a set of induced subgraphs generated from the causal graph. Accordingly, in some instances, the causal graph validation system 106 utilizes a plurality of cliques in determining whether the causal graph is valid.

In one or more embodiments, the causal graph validation system 106 determines a sink node from the clique 500 identified from the induced subgraph 400. FIG. 6 illustrates a diagram of a sink node utilized by the causal graph validation system 106 in accordance with one or more embodiments. In particular, as indicated by FIG. 6, the sink node includes the node 402c from the clique 500. Similarly, for the maximal clique comprising of nodes 402c and 402d, the sink node is 402d.

As shown in FIG. 6, the causal graph validation system 106 determines that the node 402c is a sink node based on the orientations of the edges that are incident on the node 402c. Indeed, as illustrated, both the edge 404b and the edge 404c that are incident on the node 402c are directed toward the node 402c rather than away. Thus, in one or more embodiments, the causal graph validation system 106 identifies a sink node present within a clique by determining the orientations of the edges present within the clique and identifying a node upon which only incoming edges are incident (e.g., there are not outgoing edges within that clique).

In one or more embodiments, the causal graph validation system 106 determines a set of sink nodes. In particular, as discussed above, the causal graph validation system 106 determines a set of cliques from a set of induced subgraphs generated from the causal graph. Accordingly, in some implementations, the causal graph validation system 106 utilizes a set of sink nodes in determining whether the causal graph is valid.

FIG. 7 illustrates the causal graph validation system 106 adding sink nodes to a set of sink nodes 702 in accordance with one or more embodiments. In particular, as indicated by FIG. 7, the sink nodes (e.g., the nodes 302c and 302d) are from the Markov equivalence class. Further, the sink node 302c corresponds to the sink node identified from the clique 500 (e.g., the node 402c). In other words, in one or more embodiments, after identifying the sink node from the clique 500—which originates from the causal graph—the causal graph validation system 106 identifies the corresponding node from the Markov equivalence class and adds that node to the set of sink nodes 702. The causal graph validation system also adds the sink node corresponding to the clique comprising of nodes 402c and 402d (i.e., node 302d which is the corresponding node of 402d from the Markov Equivalence Class) to the set of sink nodes 702. In some implementations, however, the causal graph validation system 106 adds the sink nodes identified from the clique 500 (e.g., the node 402c) and clique comprising of 402c and 402d (e.g., the node 402d) to the set of sink nodes 702.

In one or more embodiments, the causal graph validation system 106 utilizes the set of sink nodes 702 to determine which nodes from the Markov equivalence class to include in or omit from an intervention set. FIG. 8 illustrates the causal graph validation system 106 utilizing the set of sink nodes 702 in determining an intervention set 802 in accordance with one or more embodiments.

As shown in FIG. 8, the causal graph validation system 106 determines which nodes from the chain component 300 of the Markov equivalence class (discussed above with reference to FIG. 3) to include in or omit from the intervention set 802. In particular, as shown in FIG. 8, the causal graph validation system 106 determines to omit, from the intervention set 802, the nodes 302c and 302d that were included in the set of sink nodes 702. Further, the causal graph validation system 106 determines to include, in the intervention set 802, the nodes 302a, 302b from the chain component 300 that were not included in the set of sink nodes 702.

Accordingly, in one or more embodiments, the causal graph validation system 106 determines the intervention set 802 by identifying which nodes are included in the chain component 300 extracted from the Markov equivalence class. The causal graph validation system 106 further determines which of those nodes have been added to the set of sink nodes 702. The causal graph validation system 106 omits those nodes from the chain component 300 that have been added to the set of sink nodes from the intervention set 802 and adds the remaining nodes from the chain component 300 to the intervention set 802.

Thus, in those embodiments where the causal graph validation system 106 extracts multiple chain components from the Markov equivalence class, the causal graph validation system 106 similarly determines nodes from those chain components to add to or omit from the intervention set 802. Indeed, as previously mentioned, the causal graph validation system 106 generates multiple induced graphs from the causal graph using the chain components, identifies one or more cliques (e.g., maximal cliques) from the induced subgraphs, identifies at least one sink node from each clique, and adds the identified sink nodes to the set of sink nodes 702. Accordingly, the causal graph validation system 106 adds nodes from multiple chain components of the Markov equivalence class to the intervention set 802 while omitting the identified sink nodes.

In some cases, the size of the intervention set 802 determined by the causal graph validation system 106 is n−r where n represents the number of nodes in the causal graph (and the Markov equivalence class) and r represents the number of maximal cliques in the chain components of the Markov equivalence class.

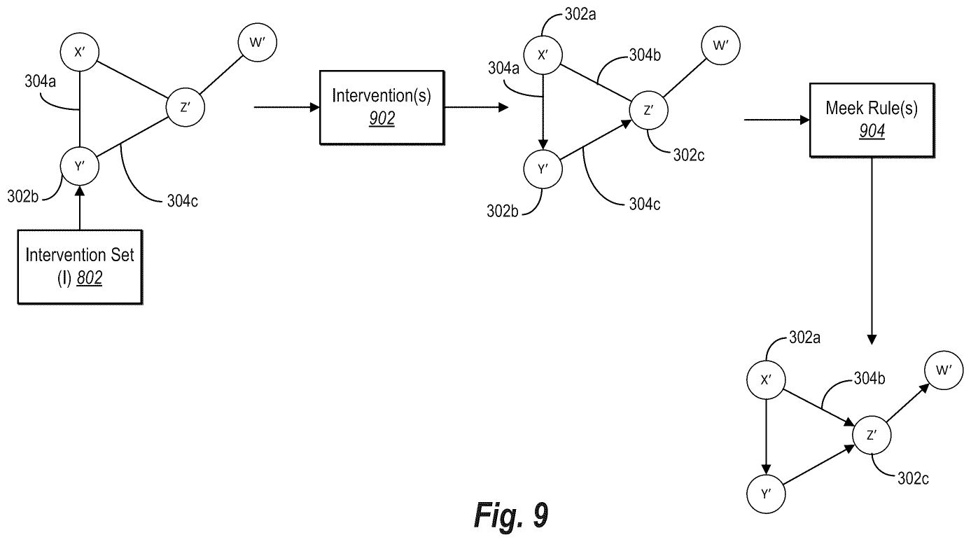

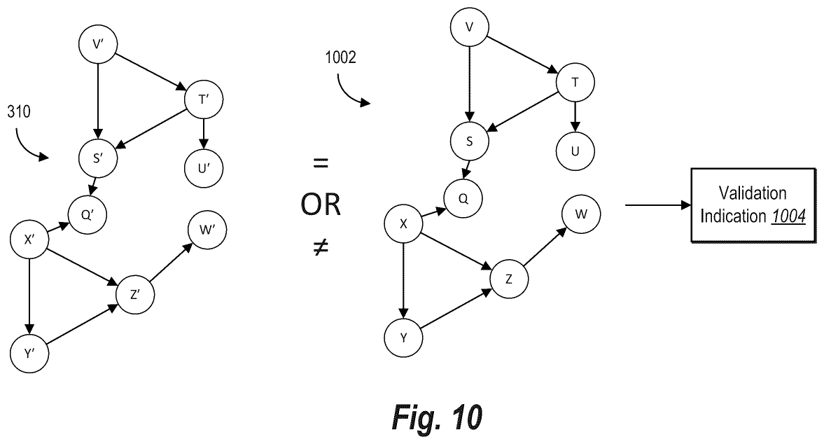

As previously mentioned, the causal graph validation system 106 utilizes a determined intervention set to learn the orientations of the undirected edges of the Markov equivalence class. By learning the orientations of the undirected edges, the causal graph validation system 106 can determine whether the causal graph is valid. FIGS. 9-10 illustrate diagrams for determining whether the causal graph is valid using an intervention set in accordance with one or more embodiments.

In particular, FIG. 9 illustrates a diagram for utilizing the intervention set 802 for determining orientations for edges incident on a node of the Markov equivalence class (the portion of the Markov equivalence class that corresponds to the chain component 300) in accordance with one or more embodiments. As shown in FIG. 9, the causal graph validation system 106 determines that the node 302b is included in the intervention set 802. Further, the causal graph validation system 106 intervenes on the node 302b to determine the orientation of edges that are incident on the node 302b (e.g., the edges 304a, 304c). In particular, the causal graph validation system 106 intervenes on the node 302b via an intervention(s) 902.

In one or more embodiments, by intervening on the node 302b, the causal graph validation system 106 randomizes the distribution of the node 302b (e.g., randomizes the variable represented by the node 302b). In some cases, upon intervening on the node 302b, the causal graph validation system 106 observes the resulting values of the other nodes. Accordingly, the causal graph validation system 106 determines the orientations of edges 304a, 304c that are incident on the node 302b. In some cases, the causal graph validation system 106 further determines the orientation of one or more edges that are not incident on the node 302b via the intervention(s) 902 on the node 302b.

In one or more embodiments, the causal graph validation system 106 intervenes on one node from the intervention set 802 at a time. In some implementations, however, the causal graph validation system 106 intervenes on multiple nodes simultaneously. In one or more embodiments, the causal graph validation system 106 intervenes on nodes from the intervention set 802 to learn edge orientations as described by Vibhor Porwal et al., Almost Optimal Universal Lower Bound for Learning Causal DAGs with Atomic Interventions, International Conference on Artificial Intelligence and Statistics (AISTATS), 2022, arxiv:2111.05070, which is incorporated herein by reference in its entirety.

As further shown in FIG. 9, the causal graph validation system 106 learns the orientation of one or more additional edges using one or more Meek rules 904. In particular, as illustrated, the causal graph validation system 106 learns the orientation of the edge 304b via the one or more Meek rules 904. To illustrate, upon learning the orientations of the edges 304a, 304c via the intervention(s) 902 on the node 302b, the causal graph validation system 106 determines orientations for all edges except for one in the group of nodes that includes the nodes 302a-302c. In particular, the causal graph validation system 106 determines that the edge 304a points from the node 302a to the node 302b and that the edge 304c points from the node 302b to the node 302c. Further, as previously discussed, in some cases, the causal graph validation system 106 defines a Markov equivalence class as not having directed cycles. Accordingly, the causal graph validation system 106 determines that the edge 304b points from the node 302a to the node 302c (otherwise the Markov equivalence class would have a directed cycle). In some cases, the direction of the edge from node 302c to node 302d is also inferred by the application of one of the Meek Rules 904. In one or more embodiments, the causal graph validation system 106 utilizes the one or more Meek rules 904 as described by Christopher Meek, Causal Inference and Causal Explanation with Background Knowledge, Proceedings of the 11th Conference on Uncertainty in Artificial Intelligence (UTA 1995), pages 403-410, 1995, arXiv:1302.4972 or by Tom S. Verma and Judea Pearl, An Algorithm for Deciding if a Set of Observed Independencies Has a Causal Explanation, Proceedings of the 8th Conference on Uncertainty in Artificial Intelligence (UAI 1992), pages 323-330, 1992, arXiv:1303.5435, both of which are incorporated herein by reference in their entirety.

Thus, in one or more embodiments, the causal graph validation system 106 utilizes a plurality of interventions (and Meek rules) on an intervention set to learn edge orientations for the Markov equivalence class. The causal graph validation system 106 intervenes on the nodes of the intervention set 802 in various orders in various implementations. In some cases, the causal graph validation system 106 implements a particular order, such as an order that has been designated via a configurable parameter.

FIG. 10 illustrates utilizing the Markov equivalence class 310 with learned edge orientations to determine whether the causal graph 1002 is valid in accordance with one or more embodiments. Indeed, as shown in FIG. 10, the causal graph validation system 106 compares the Markov equivalence class 310 with the causal graph 1002. In particular, the causal graph validation system 106 compares the edge orientations of the Markov equivalence class 310 with the edge orientations of the causal graph 1002 and generates a validation indication 1004 based on the comparison. In some cases, upon determining that the edge orientations of the Markov equivalence class 310 are the same as the edge orientations of the causal graph 1002, the causal graph validation system 106 generates the validation indication 1004 to indicate that the causal graph 1002 is valid. In some instances, upon determining that the edge orientations of the Markov equivalence class 310 are not the same as the edge orientations of the causal graph 1002, the causal graph validation system 106 generates the validation indication 1004 to indicate that the causal graph 1002 is not valid. Indeed, in some implementations, upon determining that orientation of at least one edge of the Markov equivalence class 310 is different than the orientation of the corresponding edge from the causal graph 1002, the causal graph validation system 106 determines that the causal graph 1002 is invalid.

In some embodiments, the causal graph validation system 106 determines that the causal graph 1002 is invalid during the process of intervening on the nodes from the intervention set 802. In other words, in some cases, the causal graph validation system 106 determines that the causal graph 1002 is invalid before intervening on all of the nodes from the intervention set 802. To illustrate, in some implementations, after intervening on a particular node from the intervention set 802 or applying the Meek rules after the intervention, the causal graph validation system 106 determines that the learned orientation for one of the edges is different than the orientation of the corresponding edge from the causal graph 1002. Accordingly, in some instances, the causal graph validation system 106 determines that the causal graph 1002 is invalid after only having implemented as few as one intervention. In one or more embodiments, however, intervenes on all nodes from the intervention set 802 to determine that the causal graph 1002 is valid, or at least intervene on a sufficient number of nodes to learn all edge orientations.

In some instances, the causal graph validation system 106 determines whether the causal graph 1002 is valid further based on remaining undirected edges of in the Markov equivalence class 310. In particular, upon intervening on all nodes from the intervention set 802 and determining that the Markov equivalence class 310 still includes at least one undirected edge, the causal graph validation system 106 determines that the causal graph 1002 is invalid. Indeed, in some cases, the causal graph validation system 106 determines that, if the causal graph 1002 is valid, the intervention set 802 is sufficient to learn all edge orientations of the Markov equivalence class 310 as described in Vibhor Porwal et al.

The algorithm represented below presents a characterization of how the causal graph validation system 106 determines and utilizes an intervention set of nodes to determine whether a causal graph is valid in accordance with some embodiments.

Algorithm 1

```
Input: A DAG D = (V, E), G = MEC(D)
Output: 1 when D is valid, otherwise 0
I = Ø //* Initializing the intervention set
for G′ ∈ CC(G) do
  //* CC(G) is the set of chain components of G
  //* D[V(G′)] is the induced subgraph of D over V(G′) (set of nodes of
  G′)
  D′ = D[V(G′)];
  S = Ø //* Initializing the set of sink nodes
  for Maximal clique C ∈ D′ do
    s = sink_{D′}(C);
    S = S ∪ {s};
  end
  I = I ∪ (V(G′)\S);
end
P = G;
valid = 1;
for v ∈ I do
  if un(P) == Ø then
    //* un(P) is the set of undirected edges of P.
    break;
  Intervene on v and orient the newly learned edges, E′ in P;
  Apply Meek Rules in P;
  if di(P)\di(D) ≠ Ø then
    //* di(P) and di(D) are the sets of directed edges of P and D,
    respectively
    valid = 0;
    break;
end
if di(P) ≠ di(D) then
  valid = 0;
return valid;
```

As shown in Algorithm 1, the causal graph validation system 106 takes a causal DAG D and its Markov equivalence class G as inputs and outputs whether D is the valid orientation of G. The causal graph validation system 106 determines that D is valid if and only if the directions of all edges in D are correct. In accordance with Algorithm 1, the causal graph validation system 106 returns 1 if D is valid and 0 if D is invalid.

In some cases, where D is valid, then the number of interventions used by the causal graph validation system 106 is equal to the number of interventions required to learn all the edges of D starting with its Markov equivalence class. In some instances, the number of interventions utilized by the causal graph validation system 106 to validate a causal DAG is, at most, two times the minimum number of interventions required to learn the DAG from its Markov equivalence class. Indeed, as previously mentioned, in some instances, the maximum number of interventions performed utilizing Algorithm 1 is |I|=n−r where n equals the number of nodes in the causal DAG and r represents the total number of maximal cliques in the chordal chain components of its corresponding Markov equivalence class. In some cases, however, the causal graph validation system 106 terminates Algorithm 1 before performing |I| interventions when it finds an edge of the Markov equivalence class that is directed in an opposite direction than the corresponding edge in the causal DAG.

Thus, in one or more embodiments, the causal graph validation system 106 utilizes a causal graph to determine an intervention set that includes nodes from a corresponding Markov equivalence class. The causal graph validation system 106 further intervenes on the nodes of the intervention set to determine whether the causal graph is valid. Accordingly, in one or more embodiments, the algorithms and acts described with reference to FIGS. 3-10, including Algorithm 1, can comprise the corresponding structure for performing a step for verifying that the causal graph corresponds to the set of analytics data using the Markov equivalence class.

By utilizing an intervention set to verify a causal graph, the causal graph validation system 106 operates with improved flexibility when compared to conventional systems. Indeed, the causal graph validation system 106 offers a flexible method of verifying whether a causal graph correctly portrays the causal relationships reflected in an underlying set of analytics data, which is unavailable under conventional systems.

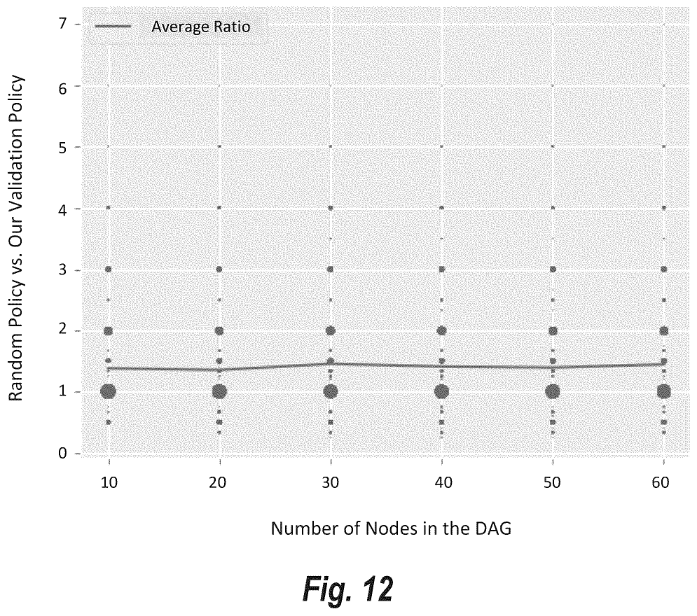

As previously mentioned, the causal graph validation system 106 further operates more efficiently when compared to conventional systems. In particular, the causal graph validation system 106 learns edge orientations with improved efficiency. In some cases, the causal graph validation system 106 performs, at most, twice the minimum number of interventions required to validate a causal graph starting from its Markov equivalence class compared to the potentially exponential number of iterations used under some conventional systems. Researchers have conducted studies to determine the efficiency of the causal graph validation system 106 compared to conventional systems. FIGS. 11-12 illustrate graphical representations of these studies.

In particular, FIG. 11 illustrates a causal graph utilized in determining the efficiency of the causal graph validation system 106 via a data study in accordance with one or more embodiments. The researchers generated the causal graph using customer retention data from the Adobe Analytics database. The researchers used the GES algorithm to learn the causal graph up to its corresponding Markov equivalence class and learned orientations for the remaining edges using a domain expert.

In the study, the researchers generated one hundred random DAGs from the Markov equivalence class that corresponds to the shown causal graph. The researchers utilized the causal graph validation system 106 to determine the validity of each DAG. The researchers further used a policy of randomly selecting nodes for intervention to compare to the performance of the causal graph validation system 106. The results of the study showed that the causal graph validation system 106 required 1.11 interventions on average over the one hundred DAGs to determine validity while the random policy required an average of 3.13 interventions.

FIG. 12 illustrates a graph reflecting additional experimental results regarding the efficiency of the causal graph validation system 106 in accordance with one or more embodiments. In particular, the graph of FIG. 12 reflects results on synthetic data where the researchers generated one thousand DAGs for each size in {10, 20, 30, 40, 50, 60}. In particular, for each n, the researchers generated one thousand graphs from the Erdos-Renyi graph model G(n, p) where, for each such graph, the connection probability p is a random number in [0.1,0.3). The undirected graphs were then converted to DAGs by imposing a random topological ordering on their respective set of nodes. These DAGs were used as the set of input DAGs to be validated. To simulate interventions for each DAG D, the researchers generated another DAG D′ in the Markov equivalence class of D and treat D′ as the true (valid) DAG.

The graph of FIG. 12 compares the performance of the causal graph validation system 106 to the random policy described above. The graph shows the ratio of the number of interventions required by the random policy and the causal graph validation system 106. The thickness of the points is proportional to the percentage of the DAGs having a particular value of the ratio. The line represented in the graph shows that the random policy requires 1.5 times more interventions on average when compared to the causal graph validation system 106.

Turning to FIG. 13, additional detail will now be provided regarding various components and capabilities of the causal graph validation system 106. In particular, FIG. 13 shows the causal graph validation system 106 implemented by the computing device 1300 (e.g., the server(s) 102 and/or one of the client devices 110a-110n discussed above with reference to FIG. 1). Additionally, the causal graph validation system 106 is also part of the analytics system 104. As shown, in one or more embodiments, the causal graph validation system 106 includes, but is not limited to, a Markov equivalence class generator 1302, an intervention set generator 1304, an intervention manager 1306, a Meek rules manager 1308, a validation indication generator 1310, and data storage 1312 (which includes a causal graph 1314 and analytics data 1316).

As just mentioned, and as illustrated in FIG. 13, the causal graph validation system 106 includes the Markov equivalence class generator 1302. In one or more embodiments, the Markov equivalence class generator 1302 generates a Markov equivalence class that corresponds to a causal graph. For instance, in some cases, the Markov equivalence class generator 1302 generates a Markov equivalence class from a set of analytics data corresponding to a causal graph using a causal structure learning algorithm.

Additionally, as shown in FIG. 13, the causal graph validation system 106 includes the intervention set generator 1304. In one or more embodiments, the intervention set generator 1304 determines an intervention set to use in validating a causal graph. In particular, the intervention set generator 1304 determines an intervention set including nodes from a Markov equivalence class that corresponds to the causal graph to be validated. For instance, in some cases, the intervention set generator 1304 extracts chain components from the Markov equivalence class, generates induced subgraphs from the causal graph using the chain components, identifies maximal cliques included in the induced subgraphs, and identifies a set of sink nodes from the maximal cliques. The intervention set generator 1304 further utilizes the set of sink nodes to determine which nodes of the Markov equivalence class to include in or omit from the intervention set.

As shown in FIG. 13, the causal graph validation system 106 further includes the intervention manager 1306. In one or more embodiments, the intervention manager 1306 intervenes on nodes of an intervention set. In particular, the intervention manager 1306 utilizes interventions on the nodes of the intervention set to determine orientations for the undirected edges of a Markov equivalence class.

Further, as shown in FIG. 13, the causal graph validation system 106 includes the meek rules manager 1308. In one or more embodiments, the meek rules manager 1308 utilizes one or more Meek rules to learn orientations for additional undirected edges of a Markov equivalence class. For instance, in some cases, the meek rules manager 1308 utilizes one or more Meek rules after intervening on a node of the intervention set to learn the orientations of one or more additional edges that were not determined via the intervention.

Additionally, as shown, the causal graph validation system 106 includes the validation indication generator 1310. In one or more embodiments, the causal graph validation system 106 generates an indication of whether a causal graph is valid. For instance, in some cases, the validation indication generator 1310 utilizes a binary indication that takes on one value if the causal graph is valid or another value if the causal graph is invalid.

Further, as shown in FIG. 13, the causal graph validation system 106 includes data storage 1312. In particular, data storage 1312 includes the causal graph 1314 (e.g., a causal graph to be validated) and the analytics data 1316 that corresponds to the causal graph 1314.

Each of the components 1302-1316 of the causal graph validation system 106 can include software, hardware, or both. For example, the components 1302-1316 can include one or more instructions stored on a computer-readable storage medium and executable by processors of one or more computing devices, such as a client device or server device. When executed by the one or more processors, the computer-executable instructions of the causal graph validation system 106 can cause the computing device(s) to perform the methods described herein. Alternatively, the components 1302-1316 can include hardware, such as a special-purpose processing device to perform a certain function or group of functions. Alternatively, the components 1302-1316 of the causal graph validation system 106 can include a combination of computer-executable instructions and hardware.

Furthermore, the components 1302-1316 of the causal graph validation system 106 may, for example, be implemented as one or more operating systems, as one or more stand-alone applications, as one or more modules of an application, as one or more plug-ins, as one or more library functions or functions that may be called by other applications, and/or as a cloud-computing model. Thus, the components 1302-1316 of the causal graph validation system 106 may be implemented as a stand-alone application, such as a desktop or mobile application. Furthermore, the components 1302-1316 of the causal graph validation system 106 may be implemented as one or more web-based applications hosted on a remote server. Alternatively, or additionally, the components 1302-1316 of the causal graph validation system 106 may be implemented in a suite of mobile device applications or “apps.” For example, in one or more embodiments, the causal graph validation system 106 can comprise or operate in connection with digital software applications such as ADOBE® ANALYTICS, ADOBE® EXPERIENCE PLATFORM, or ADOBE® CAMPAIGN. The foregoing are either registered trademarks or trademarks of Adobe Inc. in the United States and/or other countries.

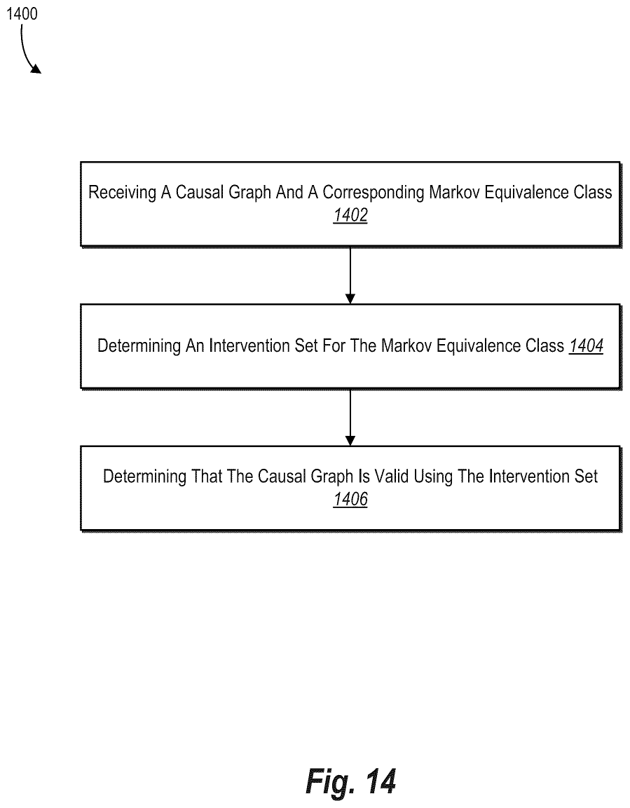

FIGS. 1-13, the corresponding text, and the examples provide a number of different methods, systems, devices, and non-transitory computer-readable media of the causal graph validation system 106. In addition to the foregoing, one or more embodiments can also be described in terms of flowcharts comprising acts for accomplishing the particular result, as shown in FIG. 14. FIG. 14 may be performed with more or fewer acts. Further, the acts may be performed in different orders. Additionally, the acts described herein may be repeated or performed in parallel with one another or in parallel with different instances of the same or similar acts.

FIG. 14 illustrates a flowchart of a series of acts 1400 for verifying a causal graph using an intervention set in accordance with one or more embodiments. FIG. 14 illustrates acts according to one embodiment, alternative embodiments may omit, add to, reorder, and/or modify any of the acts shown in FIG. 14. In some implementations, the acts of FIG. 14 are performed as part of a method. For example, in some embodiments, the acts of FIG. 14 are performed as part of a computer-implemented method. Alternatively, a non-transitory computer-readable medium can store instructions thereon that, when executed by at least one processor, cause the at least one processor to perform operations comprising the acts of FIG. 14. In some embodiments, a system performs the acts of FIG. 14. For example, in one or more embodiments, a system includes at least one memory device comprising a causal graph. The system further includes at least one processor configured to cause the system to perform the acts of FIG. 14.

The series of acts 1400 includes an act 1402 for receiving a causal graph and a corresponding Markov equivalence class. For instance, in one or more embodiments, the act 1402 involves receiving a causal graph to be validated and a Markov equivalence class that corresponds to the causal graph. In one or more embodiments, receiving the Markov equivalence class that corresponds to the causal graph comprises: receiving a set of analytics data that corresponds to the causal graph; and determining the Markov equivalence class using the set of analytics data.

Additionally, the series of acts 1400 includes an act 1404 for determining an intervention set for the Markov equivalence class. For example, in one or more embodiments, the act 1404 involves determining an intervention set using the causal graph, the intervention set comprising nodes from the Markov equivalence class.

In one or more embodiments, the causal graph validation system 106 further determines a chain component of the Markov equivalence class. Accordingly, in some cases, determining the intervention set comprises determining the intervention set using the chain component. In some embodiments, determining the chain component of the Markov equivalence class comprises determining a chordal chain component of the Markov equivalence class. In some implementations, the causal graph validation system 106 further generates an induced subgraph from the causal graph, the induced subgraph comprising nodes and edges of the causal graph that correspond to the chain component of the Markov equivalence class. Further, in some instances, determining the intervention set using the causal graph comprises: determining a maximal clique for the induced subgraph generated from the causal graph; determining a sink node from maximal clique of the induced subgraph; and adding, to the intervention set, one or more nodes of the Markov equivalence class that corresponds to the induced subgraph while omitting nodes of the Markov equivalence class that correspond to the sink nodes.

The series of acts 1400 further includes an act 1406 for determining that the causal graph is valid using the intervention set. To illustrate, in one or more embodiments, the act 1406 involves determining that the causal graph is valid using a plurality of interventions on the nodes of the intervention set.

In one or more embodiments, determining that the causal graph is valid using the plurality of interventions on the nodes of the intervention set comprises: determining orientations for edges of the Markov equivalence class using the plurality of interventions on the nodes of the intervention set; and determining that orientations of edges of the causal graph correspond to the orientations for the edges of the Markov equivalence class. For instance, in some cases, determining that the causal graph is valid using the plurality of interventions on the nodes of the intervention set comprises: determining an orientation of one or more edges of the Markov equivalence class that are incident on a node of the intervention set via an intervention of the node; and determining that the causal graph is valid using the orientation of the one or more edges of the Markov equivalence class. In some instances, the causal graph validation system 106 further determines an orientation of one or more additional edges of the Markov equivalence class using one or more Meek rules. Accordingly, in some embodiments, determining that the causal graph is valid comprises determining that the causal graph is valid using the orientation of the one or more additional edges of the Markov equivalence class.

To provide an illustration, in one or more embodiments, the causal graph validation system 106 determines, for a Markov equivalence class that corresponds to the causal graph, an intervention set by: determining a set of chain components of the Markov equivalence class; generating a set of induced subgraphs from the causal graph using the set of chain components of the Markov equivalence class; determining sink nodes from the set of induced subgraphs; and adding, to the intervention set, one or more nodes of the Markov equivalence class that correspond to the set of induced subgraphs while omitting nodes of the Markov equivalence class that correspond to the sink nodes. The causal graph validation system 106 further determines whether the causal graph is valid using a plurality of interventions on nodes of the intervention set.

In one or more embodiments, the causal graph validation system 106 determines whether the causal graph is valid using the plurality of interventions by determining that the causal graph is invalid based on determining, via an intervention, that an orientation of an edge of the Markov equivalence class is different than an orientation of a corresponding edge of the causal graph. In some cases, the causal graph validation system 106 further generates an indication that the causal graph is invalid in response to determining that the causal graph is invalid; and provides the indication that the causal graph is invalid to a client device that submitted the causal graph.

In some embodiments, the causal graph validation system 106 determines whether the causal graph is valid using the plurality of interventions on the nodes of the intervention set by determining whether the causal graph is valid using one or more Meek rules applied to the Markov equivalence class after at least one intervention of the plurality of interventions.

In some instances, determining the sink nodes from the set of induced subgraphs comprises: determining a set of maximal cliques for the set of induced subgraphs; and determining one or more sink nodes from the set of maximal cliques. In some embodiments, determining the set of chain components of the Markov equivalence class comprises determining a set of chordal chain components of the Markov equivalence class; and generating the set of induced subgraphs from the causal graph using the set of chain components comprises generating the set of induced subgraphs from the causal graph using the set of chordal chain components.

In some cases, the causal graph validation system 106 determines whether the causal graph is valid using the plurality of interventions on the nodes of the intervention set by determining whether the Markov equivalence class includes an undirected edge after orienting edges of the Markov equivalence class via the plurality of interventions on the nodes of the intervention set. For instance, in at least one implementation, the causal graph validation system 106 determines whether the causal graph is valid using the plurality of interventions on the nodes of the intervention set by determining that the causal graph is invalid based on determining that the Markov equivalence class includes at least one undirected edge after orienting edges of the Markov equivalence class via the plurality of interventions.

To provide another illustration, in one or more embodiments, the causal graph validation system 106 receives a causal graph associated with a set of analytics data and a Markov equivalence class that corresponds to the causal graph. The causal graph validation system 106 further verifies that the causal graph corresponds to the set of analytics data using the Markov equivalence class. Additionally, the causal graph validation system 106 generates a validation indication for the causal graph based on verifying that the causal graph corresponds to the set of analytics data. In some cases, receiving the Markov equivalence class comprises determining the Markov equivalence class from the set of analytics data using a causal structure learning algorithm. Further, in some instances, the causal graph validation system 106 provides the validation indication for display on a client device that submitted the causal graph.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 15 illustrates a block diagram of an example computing device 1500 that may be configured to perform one or more of the processes described above. One will appreciate that one or more computing devices, such as the computing device 1500 may represent the computing devices described above (e.g., the server(s) 102 and/or the client devices 110a-110n). In one or more embodiments, the computing device 1500 may be a mobile device (e.g., a mobile telephone, a smartphone, a PDA, a tablet, a laptop, a camera, a tracker, a watch, a wearable device). In some embodiments, the computing device 1500 may be a non-mobile device (e.g., a desktop computer or another type of client device). Further, the computing device 1500 may be a server device that includes cloud-based processing and storage capabilities.

As shown in FIG. 15, the computing device 1500 can include one or more processor(s) 1502, memory 1504, a storage device 1506, input/output interfaces 1508 (or “I/O interfaces 1508”), and a communication interface 1510, which may be communicatively coupled by way of a communication infrastructure (e.g., bus 1512). While the computing device 1500 is shown in FIG. 15, the components illustrated in FIG. 15 are not intended to be limiting. Additional or alternative components may be used in other embodiments. Furthermore, in certain embodiments, the computing device 1500 includes fewer components than those shown in FIG. 15. Components of the computing device 1500 shown in FIG. 15 will now be described in additional detail.

In particular embodiments, the processor(s) 1502 includes hardware for executing instructions, such as those making up a computer program. As an example, and not by way of limitation, to execute instructions, the processor(s) 1502 may retrieve (or fetch) the instructions from an internal register, an internal cache, memory 1504, or a storage device 1506 and decode and execute them.

The computing device 1500 includes memory 1504, which is coupled to the processor(s) 1502. The memory 1504 may be used for storing data, metadata, and programs for execution by the processor(s). The memory 1504 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1504 may be internal or distributed memory.

The computing device 1500 includes a storage device 1506 including storage for storing data or instructions. As an example, and not by way of limitation, the storage device 1506 can include a non-transitory storage medium described above. The storage device 1506 may include a hard disk drive (HDD), flash memory, a Universal Serial Bus (USB) drive or a combination these or other storage devices.

As shown, the computing device 1500 includes one or more I/O interfaces 1508, which are provided to allow a user to provide input to (such as user strokes), receive output from, and otherwise transfer data to and from the computing device 1500. These I/O interfaces 1508 may include a mouse, keypad or a keyboard, a touch screen, camera, optical scanner, network interface, modem, other known I/O devices or a combination of such I/O interfaces 1508. The touch screen may be activated with a stylus or a finger.

The I/O interfaces 1508 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1508 are configured to provide graphical data to a display for presentation to a user. The graphical data may be representative of one or more graphical user interfaces and/or any other graphical content as may serve a particular implementation.

The computing device 1500 can further include a communication interface 1510. The communication interface 1510 can include hardware, software, or both. The communication interface 1510 provides one or more interfaces for communication (such as, for example, packet-based communication) between the computing device and one or more other computing devices or one or more networks. As an example, and not by way of limitation, communication interface 1510 may include a network interface controller (NIC) or network adapter for communicating with an Ethernet or other wire-based network or a wireless NIC (WNIC) or wireless adapter for communicating with a wireless network, such as a WI-FI. The computing device 1500 can further include a bus 1512. The bus 1512 can include hardware, software, or both that connects components of computing device 1500 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A non-transitory computer-readable medium storing instructions that, when executed by at least one processor, cause the at least one processor to perform operations comprising:
receiving a causal graph to be validated and a Markov equivalence class that corresponds to the causal graph;
determining an intervention set using the causal graph, the intervention set comprising nodes from the Markov equivalence class; and
determining that the causal graph is valid using a plurality of interventions on the nodes of the intervention set.

2. The non-transitory computer-readable medium of claim 1, wherein determining that the causal graph is valid using the plurality of interventions on the nodes of the intervention set comprises:
determining orientations for edges of the Markov equivalence class using the plurality of interventions on the nodes of the intervention set; and
determining that orientations of edges of the causal graph correspond to the orientations for the edges of the Markov equivalence class.

3. The non-transitory computer-readable medium of claim 1,
further comprising instructions that, when executed by the at least one processor, cause the at least one processor to perform operations comprising:
determining a chain component of the Markov equivalence class,
wherein determining the intervention set comprises determining the intervention set using the chain component.

4. The non-transitory computer-readable medium of claim 3, wherein determining the chain component of the Markov equivalence class comprises determining a chordal chain component of the Markov equivalence class.

5. The non-transitory computer-readable medium of claim 3, further comprising instructions that, when executed by the at least one processor, cause the at least one processor to perform operations comprising generating an induced subgraph from the causal graph, the induced subgraph comprising nodes and edges of the causal graph that correspond to the chain component of the Markov equivalence class.

6. The non-transitory computer-readable medium of claim 5, wherein determining the intervention set using the causal graph comprises:
determining a maximal clique for the induced subgraph generated from the causal graph;
determining a sink node from that maximal clique of the induced subgraph; and
adding, to the intervention set, one or more nodes of the Markov equivalence class that corresponds to the induced subgraph while omitting nodes of the Markov equivalence class that correspond to the sink nodes.

7. The non-transitory computer-readable medium of claim 1, wherein determining that the causal graph is valid using the plurality of interventions on the nodes of the intervention set comprises:
determining an orientation of one or more edges of the Markov equivalence class that are incident on a node of the intervention set via an intervention of the node; and
determining that the causal graph is valid using the orientation of the one or more edges of the Markov equivalence class.

8. The non-transitory computer-readable medium of claim 7,
further comprising instructions that, when executed by the at least one processor, cause the at least one processor to perform operations comprising determining an orientation of one or more additional edges of the Markov equivalence class using one or more Meek rules,
wherein determining that the causal graph is valid comprises determining that the causal graph is valid using the orientation of the one or more additional edges of the Markov equivalence class.

9. The non-transitory computer-readable medium of claim 1, wherein receiving the Markov equivalence class that corresponds to the causal graph comprises:
receiving a set of analytics data that corresponds to then causal graph; and
determining the Markov equivalence class using the set of analytics data.

10. A system comprising:
at least one memory device comprising a causal graph; and
at least one processor configured to cause the system to:
determine, for a Markov equivalence class that corresponds to the causal graph, an intervention set by:
determining a set of chain components of the Markov equivalence class;
generating a set of induced subgraphs from the causal graph using the set of chain components of the Markov equivalence class;
determining sink nodes from the set of induced subgraphs; and
adding, to the intervention set, one or more nodes of the Markov equivalence class that correspond to the set of induced subgraphs while omitting nodes of the Markov equivalence class that correspond to the sink nodes; and
determine whether the causal graph is valid using a plurality of interventions on nodes of the intervention set.

11. The system of claim 10, wherein the at least one processor is configured to cause the system to determine whether the causal graph is valid using the plurality of interventions by determining that the causal graph is invalid based on determining, via an intervention, that an orientation of an edge of the Markov equivalence class is different than an orientation of a corresponding edge of the causal graph.

12. The system of claim 11, wherein the at least one processor is further configured to cause the system to:
generate an indication that the causal graph is invalid in response to determining that the causal graph is invalid; and
providing the indication that the causal graph is invalid to a client device that submitted the causal graph.

13. The system of claim 10, wherein the at least one processor is configured to cause the system to determine whether the causal graph is valid using the plurality of interventions on the nodes of the intervention set by determining whether the causal graph is valid using one or more Meek rules applied to the Markov equivalence class after at least one intervention of the plurality of interventions.

14. The system of claim 10, wherein determining the sink nodes from the set of induced subgraphs comprises:
determining a set of maximal cliques for the set of induced subgraphs; and
determining one or more sink nodes from the set of maximal cliques.

15. The system of claim 10, wherein the at least one processor is configured to cause the system to determine whether the causal graph is valid using the plurality of interventions on the nodes of the intervention set by determining whether the Markov equivalence class includes an undirected edge after orienting edges of the Markov equivalence class via the plurality of interventions on the nodes of the intervention set.

16. The system of claim 15, wherein the at least one processor is configured to cause the system to determine whether the causal graph is valid using the plurality of interventions on the nodes of the intervention set by determining that the causal graph is invalid based on determining that the Markov equivalence class includes at least one undirected edge after orienting edges of the Markov equivalence class via the plurality of interventions.

17. The system of claim 10, wherein:
determining the set of chain components of the Markov equivalence class comprises determining a set of chordal chain components of the Markov equivalence class; and
generating the set of induced subgraphs from the causal graph using the set of chain components comprises generating the set of induced subgraphs from the causal graph using the set of chordal chain components.

18. A computer-implemented method comprising:
receiving a causal graph associated with a set of analytics data and a Markov equivalence class that corresponds to the causal graph;
performing a step for verifying that the causal graph corresponds to the set of analytics data using the Markov equivalence class; and
generating a validation indication for the causal graph based on verifying that the causal graph corresponds to the set of analytics data.

19. The computer-implemented method of claim 18, wherein receiving the Markov equivalence class comprises determining the Markov equivalence class from the set of analytics data using a causal structure learning algorithm.

20. The computer-implemented method of claim 18, further comprising providing the validation indication for display on a client device that submitted the causal graph.
